(19) United States
(12) Patent Application Publication
(10) Pub. No.: US 2006/0135054 A1
(43) Pub. Date: Jun. 22, 2006

(54) Air inlet, in particular for a motor vehicle

(75) Inventors: Reinhold Burr, Heidenheim (DE); Diertrich Klingler, Heubach (DE); Klaus Voigt, Bietigheim-Bissingen (DE)

Correspondence Address: FOLEY AND LARDNER LLP;SUITE 500, 3000 K STREET NW, WASHINGTON, DC, 20007, US

(73) Assignee: BEHR GmbH & CO. KG

(21) Appl. No.: 10/528,566

(22) PCT Filed: Sep. 19, 2003
(86) PCT No.: PCT/EP03/10436

§ 371 Date: Dec. 14, 2005

(30) Foreign Application Priority Data
Sep. 20, 2002 (DE) 102 43 974.5

(51) Int. Cl. B60H 1/34

(52) U.S. Cl. 454/155

(57) ABSTRACT

The invention relates to an air inklet (1), in particular for a motor vehicle, comprising an air duct (2), for supply of air, a metering device (3) and an air guidance device (4), whereby the air in said air guidance device (4) is at least partly divided into second part channels (11, 12) and in the inlet region (10) no significant direction change for the part channels (11, 12) is provided.

The invention relates to an air inlet, in particular for a motor vehicle, in accordance with the preamble of claim 1.

EP 1 223 061 A2 has disclosed an air inlet, in particular for vehicle air-conditioning, having a frame, a plurality of lamellae, which are arranged such that they can pivot about a first axis, and at least one coupling element, to which each of the lamellae is coupled, it being possible for the coupling element to be displaced relative to the first axis between a neutral position, in which the lamellae are parallel to one another, and a comfort position, in which at least some of the lamellae can be pivoted in opposite directions. The air inlet is arranged upstream of an outlet, from which an airstream emerges, the direction of which can be adjusted with the aid of the air inlet. The airstream can be fanned out with the aid of the lamellae that can be pivoted in opposite directions, thereby generating a divergent airstream in which the flow velocities are lower than with an airstream with a constant cross section, so that with a high throughput of air it is possible to prevent the emerging airstream from blowing onto a vehicle occupant at a high velocity. However, an air inlet of this type still leaves something to be desired.

It is an object of the invention to provide an improved air inlet.

This object is achieved by an air inlet having the features of claim 1. Advantageous configurations form the subject matter of the subclaims.

The invention provides an air inlet having an air duct supplying air, and a metering device arranged at the end of the air duct and an air-guiding device, in which air inlet the air in the air-guiding device, at least in regions, is divided into a plurality of subducts, in particular two subducts. In this case, at least in the entry region of the air-guiding device, there is no significant change in direction provided apart from the division into the subducts. The division of the air duct, which initially forms a single-part duct, takes place at a certain distance from the exit of the air from the air-guiding device, preferably at a distance of from 1 to 10, in particular 2 to 5, times the mean diameter of the air duct in the corresponding region upstream of the exit from the air-guiding device, and continues substantially until immediately before or into the metering device. A configuration of this nature is inexpensive to implement and, in addition to being simple to assemble with a low weight, also offers a low pressure drop on the air side.

It is preferable for the air duct to have an elbow, with the air being divided into a plurality of, in particular two, subducts in the region of the elbow. The elbow is preferably part of the air-guiding device. The angle of the elbow is preferably from 60° to 120°, in particular from 80° to 100°, preferably 90°.

The division into the region with two part-streams in the entry region of the air-guiding device is preferably axially-symmetrical, i.e. is effected in the radial direction, in particular in the plane defined by the longitudinal centre axis of the air duct and the centre line of the elbow.

It is preferable for the metering device to be arranged upstream of the air-guiding device, in particular upstream of the elbow, which may preferably also be part of the air-guiding device.

The air-guiding device is preferably designed in such a manner that in the outlet region of the air duct a middle region of the air duct and an outer region of the air duct are provided, and air can be fed to these regions through different subducts. The distribution of the air between the individual subducts can be controlled by means of a metering device. In this case, a spot action can preferably be imparted to the air at the exit with the aid of one of the subducts and a swirl can be imparted to the air at the exit with the aid of another subduct, thereby effecting a diffuse setting. For this purpose, it is preferable to provide a device which imparts a swirl to the corresponding partial airstream. It is also possible to use an elongate, helical region of the air-guiding device, which likewise produces a swirling motion.

It is preferable for the metering device to be designed in such a manner that the airstreams in the individual subducts can be controlled, in particular independently of one another. It is preferable for the metering device to control both the distribution of the incoming air between the individual subducts and the respective metering thereof. This allows accurate metering.

It is preferable for the metering device provided to be an actuating device which has a double flap controlled by means of one or more cam discs or by means of a kinematic mechanism. This allows direct manual adjustment by the vehicle occupant using a rotary button, so that there is no need for an actuating motor, transmission mechanism or the like.

In the text which follows, the invention is explained in detail on the basis of an exemplary embodiment and with reference to the drawing, in which:

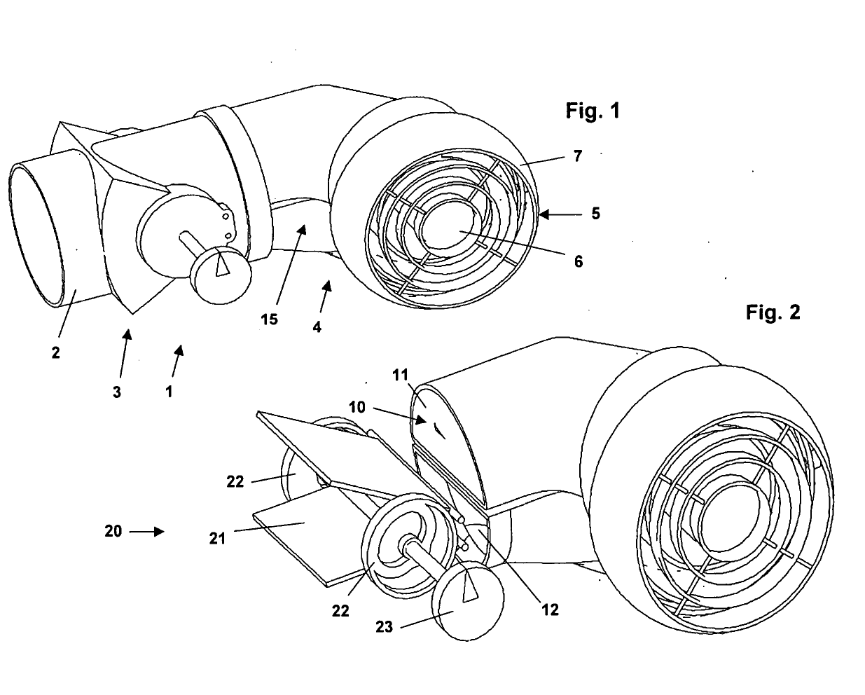

FIG. 1 shows a view of an air inlet,

FIG. 2 shows a partially open view of the air inlet shown in FIG. 1,

FIG. 3 shows a schematic view of the possible flow profiles in the air inlet shown in FIG. 1,

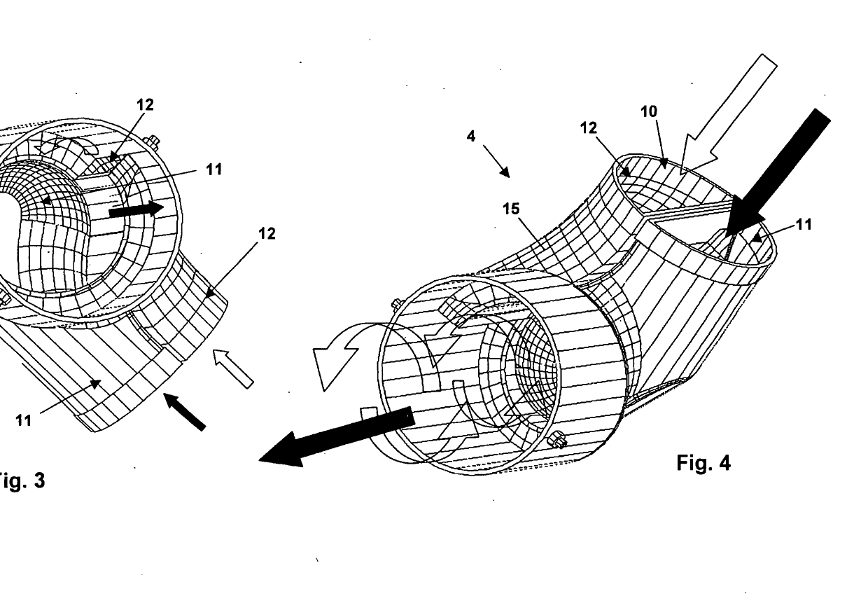

FIG. 4 shows another schematic view of the possible flow profiles in the air inlet shown in FIG. 1,

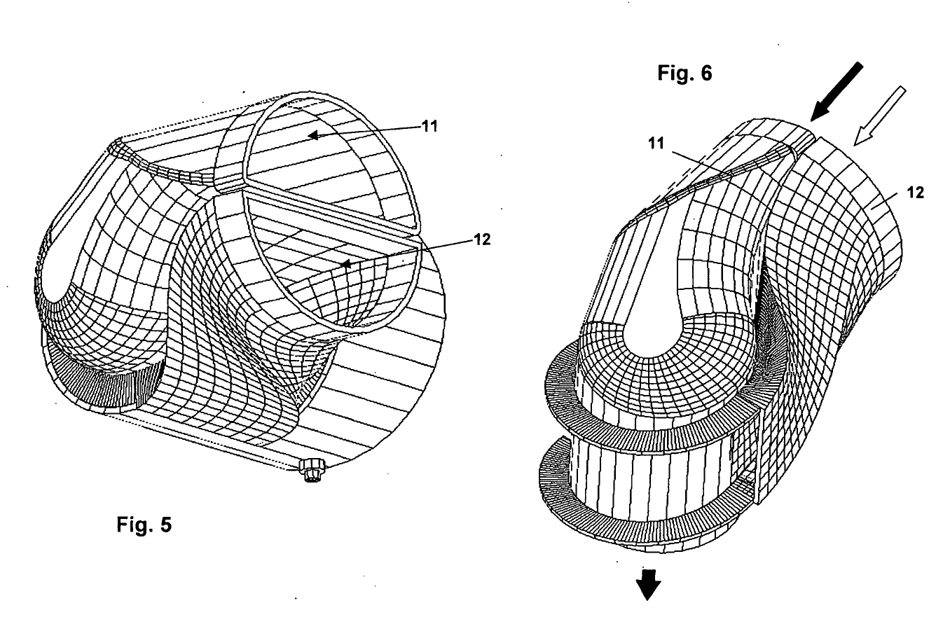

FIG. 5 shows a detail view of the elbow region of the air inlet shown in FIG. 1, and

FIG. 6 shows another, partially sectional detail view of the elbow region of the air inlet shown in FIG. 1.

An air inlet 1 according to the invention, as illustrated in the figures, is connected to an air duct 2 and comprises a metering device 3, which is still arranged in the region of the air duct 2, an air-guiding device 4, which is arranged downstream of the metering device 3, and a device 5 for setting the direction of the airstream, which is arranged in the region of the exit opening 6. This device 5 has a pivotable ring 7 with annular air-guide vanes and is configured in a way which is fundamentally known. The exit opening 6 and therefore also the device 5 for setting the direction of the airstream are installed in the dashboard (not shown) of a motor vehicle, and consequently the vehicle occupant can directly set the desired direction of the airstream.

The air-guiding device 4 is designed in such a manner that at its entry region 10 the air duct 2 is divided into two subducts 11 and 12 of substantially equal size. The division is effected in the radial direction, transversely with respect to the substantially circular cross section of the air duct 2. No change in direction with respect to the direction of the air duct 2 is provided in the initial region, also referred to as the entry region of the air-guiding device 4.

A 90° elbow 15 is arranged following the entry region of the air-guiding device 4. One of the two subducts 11, 12, referred to below as the middle subduct 11, passes directly through the 90° elbow 15, so that the air flowing through it reaches the exit opening 6 substantially without a swirling component, as indicated by solid arrows in the region of the air exit in FIGS. 3 and 4. The air which enters the middle subduct 11 is likewise indicated by a solid arrow. The other subduct 12, referred to below as outer subduct 12, is diverted in such a manner that it is routed in coiled form around the middle subduct 11 and thereby acquires a swirling component, in the counterclockwise direction in accordance with the exemplary embodiment, as indicated in FIGS. 3 and 4 by the white arrows in the region of the air exit. The air which enters the outer subduct 12 is likewise indicated by a white arrow.

In accordance with the present exemplary embodiment, the metering device 3 provided is an actuating device 20 having a double flap 21, which is arranged parallel to the division of the duct 2 and can be controlled, by means of two cam discs 22 connected to one another by a shaft, in such a manner that each subduct 11, 12 can be opened and closed individually. Control is effected by the vehicle occupant using an actuating member 23, in the present case a rotary button, which is arranged at the dashboard (not shown) and is directly connected to the shaft.

The air inlet 1 functions as follows: when the double flap 21 is in a position which opens up both subducts 11 and 12, an approximately equal airstream passes into each of the two subducts 11 and 12. The air flowing through the middle subduct 11 passes directly through the elbow 15 and is released into the interior of the vehicle in a substantially straight direction and with a sufficiently uniform flow profile, given a straight setting of the ring 7. The air flowing through the outer subduct 12 passes into the coiled part of the air-guiding device 4 and thereby acquires a swirling component, which in the region of the exit opening 6 ensures that the overall airstream made up of the partial airstreams quickly spreads out.

If one part of the double flap 21 closes off the outer subduct 12 and the middle subduct 11 is open, the air passes exclusively through the middle subduct 11 to the exit opening 6, so that a substantially swirl-free air jet is discharged to the interior of the vehicle (spot action).

On the other hand, if the other part of the double flap 21 closes off the middle subduct 11 and the outer subduct 12 is open, the air passes exclusively through the coiled part of the air-guiding device 4 and thereby acquires the swirling component referred to above, which is also still present at the exit opening 6 and is responsible for strongly swirling up the air (diffuse setting).

Intermediate ranges can be actuated as desired, thereby allowing accurate metering of the airstream with the aid of the air inlet 1. The nozzle can also be closed completely by closing the two subducts simultaneously.

### LIST OF DESIGNATIONS

1 Air inlet
2 Air duct
3 Metering device
4 Air-guiding device
5 Device
6 Exit opening
7 Ring
10 Entry region
11 Middle subduct
12 Outer subduct
15 Elbow
20 Actuating device
21 Double flap
22 Cam disc
23 Actuating member

1. An air inlet, in particular for a motor vehicle, having an air duct (2) supplying air, a metering device (3) and an air-guiding device (4), characterized in that the air in the air-guiding device (4), at least in regions, is divided into a plurality of subducts (11, 12), without any significant change in direction of the subducts (11, 12) being provided in the divided entry region (10).

2. The air inlet as claimed in claim 1, characterized in that the air-guiding device (4) has a partition which, at least in regions, runs as an extension of the longitudinal direction of the air duct (2).

3. The air inlet as claimed in claim 1, characterized in that the division of the air duct (2) into a plurality of subducts (11, 12) is provided for at a distance of 1 to 10, in particular 2 to 5, times the mean diameter of the air duct (2) in the corresponding region upstream of the exit of the air from the air-guiding device (4).

4. The air inlet as claimed in claim 1, characterized in that the air-guiding device (4) has an elbow (15), with the air being divided into a plurality of, in particular two, subducts (11, 12) in the region of the elbow (15).

5. The air inlet as claimed in claim 4, characterized in that the angle of the elbow (15) is from 60° to 120°, in particular from 80° to 100°.

6. The air inlet as claimed in claim 5, characterized in that the angle of the elbow (15) is 90°.

7. The air inlet as claimed in claim 1, characterized in that the division in the entry region (10) into the region with two subducts (11, 12) is axially symmetrical.

8. The air inlet as claimed in claim 1, characterized in that the metering device (3) is arranged upstream of the air-guiding device (4).

9. The air inlet as claimed in claim 1, characterized in that the air-guiding device (4) is designed in such a manner that a middle region and an outer region, to which air can flow through different subducts (11, 12), are provided in the outflow region from the air-guiding device (4).

10. The air inlet as claimed in claim 1, characterized in that the air-guiding device (4) has a coiled or elongate, helical region.

11. The air inlet as claimed in claim 1, characterized in that the metering device (3) is designed in such a manner that the air which can be fed to the individual subducts (11, 12) is controllable.

12. The air inlet as claimed in claim 1, characterized in that the metering device (3) controls both the distribution of the incoming air between the individual subducts (11, 12) and the metering thereof.

13. The air inlet as claimed in claim 1, characterized in that the metering device (3) provided is an actuating device (20) which has a double flap (21) controlled by means of a cam disc (22) or a kinematic mechanism.

14. The air inlet as claimed in claim 13, characterized in that the actuating device (20) is connected directly, via a shaft, to an actuating member (23).
